(19) United States
(12) Patent Application Publication
(10) Pub. No.: US 2007/0229087 A1
(43) Pub. Date: Oct. 4, 2007

(54) Ion Balance Sensor

(75) Inventor: Kazuo Okano, Machida-city (JP)

Correspondence Address: BIRCH STEWART KOLASCH & BIRCH, PO BOX 747, FALLS CHURCH, VA, 22040-0747, US

(73) Assignee: HUGLE ELECTRONICS INC., Tokyo (JP)

(21) Appl. No.: 11/596,890

(22) PCT Filed: Jun. 1, 2005
(86) PCT No.: PCT/JP05/10444

§ 371 Date: Nov. 17, 2006

(30) Foreign Application Priority Data
Jul. 5, 2004 (JP) 2004-198346

(51) Int. Cl. G01N 27/62

(52) U.S. Cl. 324/464

(57) ABSTRACT

To enable accurate detection of ion balance with a simple configuration, thereby enabling small size and reduction of a manufacturing cost, and detection of the ion balance near the surface of an object to be discharged.

An ion balance sensor includes an antenna 20 charged with positive ions or negative ions, and a normally-on type MOSFET 11 in which a gate electrode G is connected to the antenna 20, an ion balance-detecting resistance R is connected between a grounded source electrode S and the gate electrode G, and a DC power source V_{DS} and a load resistance R_{L} are serially connected between the source electrode S and a drain electrode D. A voltage of the gate electrode G is changed due to a voltage drop by a current flowing between the charged antenna 20 and an earth via the ion balance-detecting resistance R, and a change of drain current due to the voltage of the gate electrode G is detected, thereby detecting positive and negative balance of ions used for charging the antenna 20.

### TECHNICAL FIELD

The present invention relates to an ion balance sensor used for balancing the amount of positive and negative ions in a manufacturing process of semiconductor devices or the like, when the positive and negative ions are sprayed to the devices by an ionizer to discharge the devices, in order to prevent electrification of the devices.

### BACKGROUND ART

As a conventional art of the ion balance sensor used for this type of ionizer (discharger), for example, one disclosed in Japanese Patent Application Laid-Open No. 2003-217892 (paragraphs [0012] to [0021] and FIGS. 1 to 3) is known.

In the conventional art, two electrostatic potential sensors are provided in an ion balance measuring apparatus, with an electrostatic potential sensor for measuring electrostatic potential of an object to be discharged being directed to the object, an electrostatic potential sensor for measuring electrostatic potential around the own ion balance measuring apparatus being arranged so as not to be directed to the object, a difference between the measurement values of the two electrostatic potential sensors is calculated, and an error included in the measurement values of the electrostatic potential of the object due to an influence of ions around the own apparatus is reduced, thereby measuring the electrostatic potential of the object.

As another conventional art, as described in Japanese Patent Application Laid-Open No. 2001-43992 (for example, paragraphs [0021] to and FIG. 5), positive/negative ion output-balancing method and apparatus are known, in which a mesh-like ion balance sensor is arranged at a supply opening of an ionizer, and a voltage measured by the ion balance sensor is compared with a reference value, to control on/off of positive and negative high-voltage power sources based on the comparison result, thereby appropriately maintaining the ion balance.

In the invention described in Patent document 1, since two electrostatic potential sensors and a calculator are required, a circuit configuration of the ion balance measuring apparatus becomes complicated, and as a result, the ion balance measuring apparatus becomes large and the manufacturing cost increases.

In the invention described in Patent document 2, only the ion balance near the supply opening of the ionizer is controlled, and the ion balance on the surface of an actual object to be discharged cannot be controlled accurately.

Therefore, it is an object of the present invention to provide an ion balance sensor that can detect the ion balance accurately with a simple configuration, enabling small size and reduction of the manufacturing cost, and can detect the ion balance near the surface of the object to be discharged.

### DISCLOSURE OF THE INVENTION

To achieve the above object, the invention according to claim 1 is an ion balance sensor comprising: an antenna charged with positive ions or negative ions; and a normally-on type MOSFET in which the antenna is connected to a gate electrode, an ion balance-detecting resistance is connected between a grounded source electrode and the gate electrode, and a DC power source and a load resistance are serially connected between the source electrode and a drain electrode, wherein a voltage of the gate electrode is changed due to a voltage drop by a current flowing between the charged antenna and an earth via the ion balance-detecting resistance, and a change of drain current due to the voltage of the gate electrode is detected, thereby detecting positive and negative balance of ions used for charging the antenna.

The invention according to claim 2 is an ion balance sensor comprising: an antenna charged with positive ions or negative ions; and a normally-off type n-channel MOSFET and a normally-off type p-channel MOSFET, in each of which the antenna is connected to a gate electrode, an ion balance-detecting resistance is connected between a grounded source electrode and the gate electrode, and a DC power source and a light-emitting diode (LED) are serially connected between the source electrode and a drain electrode, wherein a voltage of the gate electrode is changed due to a voltage drop by a current flowing between the charged antenna and an earth via the ion balance-detecting resistance, and a drain current of either one of the MOSFETs is increased by the voltage of the gate electrode, so that the LED on this MOSFET side is allowed to emit light, thereby detecting positive and negative balance of ions used for charging the antenna.

The invention according to claim 3 is the ion balance sensor according to claim 1 or 2, wherein the ion balance-detecting resistance is formed of a plurality of resistances having a different value of resistance, and one of the resistances is selected and connected between the source electrode and the gate electrode.

The invention according to claim 4 is the ion balance sensor according to any one of claims 1 to 3, wherein a hollow space is formed by a probe constituting the antenna, and the MOSFET including the gate electrode and the ion balance-detecting resistance are built in the space.

The invention according to claim 5 is the ion balance sensor according to any one of claims 1 to 4, wherein a resistance of the ion balance-detecting resistance is set to be smaller than a resistance in the opposite direction of a protective diode connected between the source electrode and the gate electrode of the MOSFET for preventing electrostatic breakdown.

According to the present invention, electric current flows between the antenna charged with positive ions or negative ions and the earth via the ion-balance-detecting resistance, and a voltage is applied to the gate electrode of the MOSFET due to a voltage drop in the resistance. Since the channel of the MOSFET is controlled according to the voltage and the drain current changes, by extracting the change of the drain current as a voltage change, it can be detected with which ions the antenna has been charged. In other words, ion balance of the positive and negative ions can be detected.

In the present invention, since the circuit configuration is very simple, the circuit can be made small and the manufacturing cost can be reduced. Further, since the antenna can be used near the object to be discharged, the ion balance at a position where the positive and negative ions reach can be accurately detected, and hence, it is remarkably useful when it is applied to a manufacturing process of semiconductor devices or the like.

### BRIEF DESCRIPTION OF THE DRAWINGS

FIG. 1 is a circuit configuration diagram for showing a first embodiment of the present invention;

FIG. 2 is an explanatory diagram of an operation in the first embodiment of the present invention;

FIG. 3 is a circuit configuration diagram for showing a second embodiment of the present invention;

FIG. 4 is a circuit configuration diagram for showing a third embodiment of the present invention;

FIG. 5 is a circuit configuration diagram for showing a fourth embodiment of the present invention; and

FIG. 6 is a circuit configuration diagram for showing a fifth embodiment of the present invention.

### BEST MODES FOR CARRYING OUT THE INVENTION

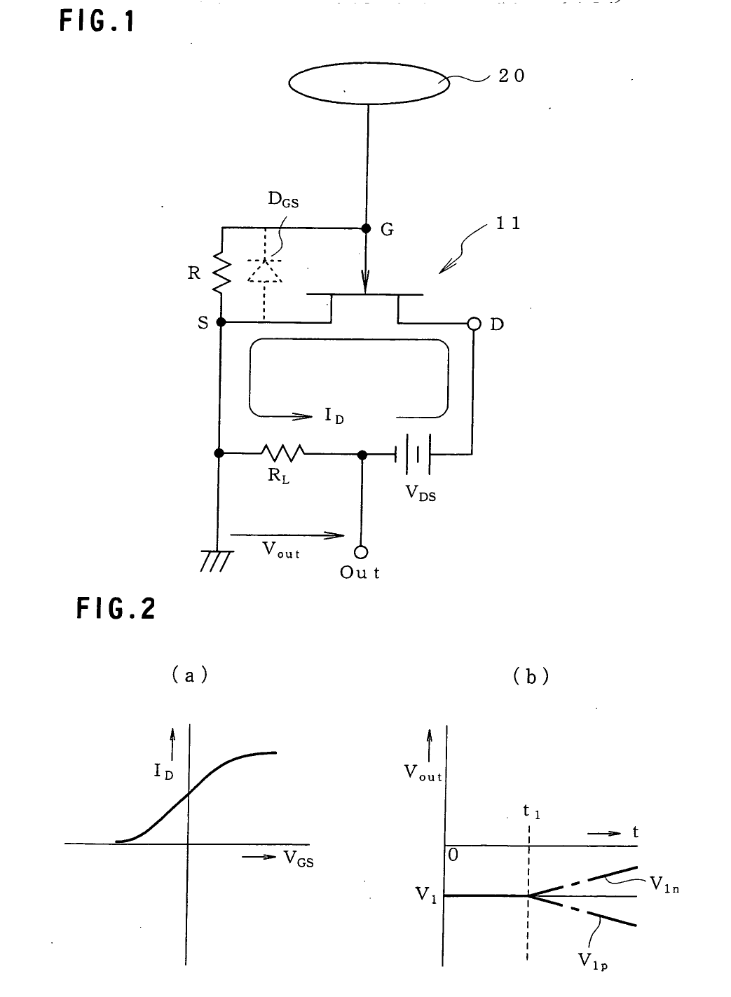

Best modes for carrying out the invention will be explained below with reference to the drawings. FIG. 1 is a block diagram of an ion balance sensor according to a first embodiment of the present invention, which corresponds to the invention of claim 1.

In FIG. 1, reference numeral 11 denotes a normally-on type (depression type) n-channel MOSFET, in which a conductive antenna 20 is connected to a gate electrode G. Positive and negative ions generated by an ionizer (not shown) are sprayed to the antenna 20. In other words, by arranging the antenna 20 near the surface of an object to be discharged such as a semiconductor device, the antenna 20 catches the positive and negative ions.

A load resistance R_{L} and a DC power source V_{DS} are serially connected between a source electrode S and a drain electrode D of an MOSFET 11. The source electrode S is grounded (connected to a bulk electrode). Reference sign Out denotes an output terminal derived from between the load resistance R_{L} and the DC power source V_{DS}.

Reference sign D_{GS} denotes a protective diode built in beforehand in a manufacturing process in order to prevent electrostatic breakdown of the MOSFET 11, which is connected between the gate electrode G and the source electrode S with the illustrated polarity.

In the first embodiment, an ion balance-detecting resistance R is connected between the gate electrode G and the source electrode S. It is assumed here that a resistance of the resistance R is a known value sufficiently lower than a resistance in the opposite direction of the protective diode D_{GS}.

An operation in the first embodiment is explained next.

Since the MOSFET 11 is the normally-on type, it has a known characteristic as shown in FIG. 2(a), and a channel (n-channel in the example shown in FIG. 1) is formed between the source electrode S and the drain electrode D, in the state where the gate voltage (V_{GS}) is 0 [V], and a drain current I_{D} flows from the DC power source V_{DS}. The state where the gate voltage (V_{GS}) is 0 [V] corresponds to a state where the antenna 20 is not charged to either positive or negative, and the positive and negative ions sprayed from the ionizer are well balanced.

It is assumed that a voltage V_{OUT} of the output terminal Out is V₁ (negative value) as shown in FIG. 2(b).

When the positive ions increases than the negative ions on and after time t₁ in FIG. 2(b), electric current flows from the antenna 20 toward the earth via the ion balance-detecting resistance R due to the excessive positive ions. As a result, the voltage V_{GS} making the gate electrode G side positive is generated at the opposite ends of the resistance R, and the voltage is applied between the gate and the source. Since the voltage V_{GS} acts so as to enlarge the n-channel of the MOSFET 11, the drain current I_{D} increases as compared to on or before time t₁, and as a result, the voltage V_{OUT} increases on the negative side and changes as shown by V₁ₚ in FIG. 2(b).

When the negative ions increases than the positive ions on and after time t₁, electric current flows from the earth side toward the antenna 20 via the ion balance-detecting resistance R due to the excessive negative ions of the antenna 20, and hence, the voltage V_{GS} making the gate electrode G side negative is generated at the opposite ends of the resistance R. Since the voltage V_{GS} acts so as to narrow the n-channel, the drain current I_{D} decreases as compared to on and before time t₁, and as a result, the voltage V_{OUT} increases on the positive side and changes as shown by V₁ₙ in FIG. 2(b).

By setting the resistance of the ion balance-detecting resistance R to a value sufficiently lower than the resistance in the opposite direction of the protective diode D_{GS} connected parallel therewith, the combined resistance of these becomes predominant by the resistance R. Accordingly, a voltage drop due to the current flowing from the antenna 20 charged to either positive or negative through the resistance R can be reliably detected as the voltage V_{GS} between the gate and the source.

Particularly, it is difficult to obtain a desired value as the resistance in the opposite direction of the protective diode D_{GS}, which is likely to be affected by a temperature change and has a difference according to individual MOSFET. Therefore, use of the resistance R whose value is known contributes to a reliable operation of the MOSFET 11 corresponding to the ion balance.

According to the first embodiment, the output voltage V_{OUT} in the state of V_{GS}=0, which means that the ions are well balanced, is measured beforehand, and the polarity of the excessive ions used for charging the antenna 20, in other words, an unbalanced state of the positive and negative ions sprayed to the antenna 20 can be detected according to which side of positive and negative sides the voltage V_{OUT} changes.

Therefore, the positive and negative ion balance can be appropriately controlled by adjusting the positive or negative voltage to be applied to an emitter of the ionizer according to feed-back control corresponding to the detected unbalanced state.

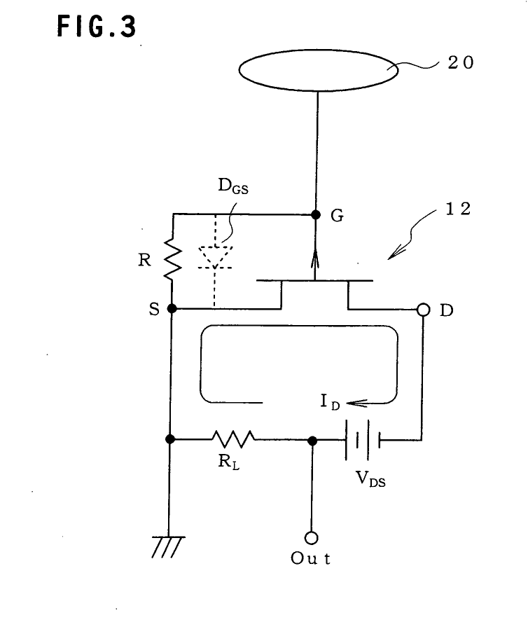

FIG. 3 shows a second embodiment in which a normally-one type p-channel MOSFET 12 is used, which also corresponds to the invention of claim 1. The circuit configuration is similar to that of FIG. 1, except of the polarity of the DC power source V_{DS} and the protective diode D_{GS}.

Also in the second embodiment, the unbalanced state of the positive and negative ions can be detected based on to which polarity the output voltage V_{OUT} changes from the state of V_{GS}=0 in which ions are well balanced.

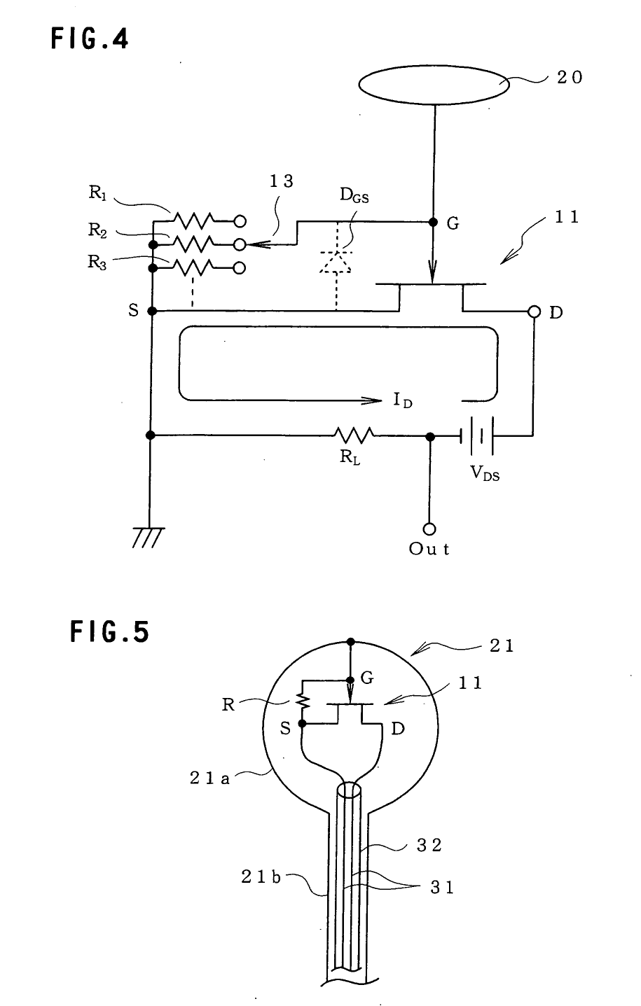

FIG. 4 shows a third embodiment of the present invention, which corresponds to the invention of claim 3.

In the first and the second embodiments, if unbalance between the positive and negative ions is large, the voltage V_{GS} applied to the gate electrode G increases due to a voltage drop of the ion balance-detecting resistance R, and the drain current I_{D} saturates, thereby making it impossible to detect the state of change of the output voltage V_{OUT} due to the drain current I_{D}.

In the third embodiment, therefore, a plurality of resistances having a different resistance (each resistance has a value sufficiently lower than a resistance in the opposite direction of the protective diode D_{GS}) is provided in parallel as the ion balance-detecting resistance, and an ion balance-detecting resistance having an optimum resistance can be selected for a target discharging system.

In other words, in FIG. 4, R₁, R₂, R₃, . . . are ion balance-detecting resistances any one of which is selectively connected between the gate electrode G and the source electrode S by a selector switch 13, and other configuration is the same as in FIG. 1. In FIG. 4, an n-channel MOSFET 11 is used, but needless to say, it can be applied to the p-channel MOSFET 12 shown in FIG. 3.

The operation thereof is the same as in the first embodiment shown in FIG. 1, except that any one of the ion balance detecting resistances R₁, R₂, R₃, . . . having a different resistance can be selected by the selector switch 13. For example, when the drain current I_{D} saturates due to unbalance of the positive and negative ions in a state where a certain resistance R₁ is connected between the gate electrode G and the source electrode S, and there is no change in the output voltage V_{OUT}, the selector switch 13 needs to be changed over so as to select another resistance R₂, R₃, or the like, which generates the voltage V_{GS} putting the drain current I_{D} in a nonsaturated region.

FIG. 5 shows a fourth embodiment of the present invention, which corresponds to the invention of claim 4.

In the first to the third embodiments, when noise is mixed in a lead wire between the antenna 20 and the gate electrode G from the circumference, regardless of the charging polarity of the antenna 20, there is a possibility that the MOSFET is turned on due to the noise, thereby increasing the drain current I_{D}. The fourth embodiment is for solving this problem.

That is, a probe 21 including a hollow spherical portion 21a and a tubular portion 21b is formed as a conductive member corresponding to the antenna 20 in the first to the third embodiments, and the MOSFET 11 itself including the gate electrode G is built in the spherical portion 21a, and one point of the spherical portion 21a is connected to the gate electrode G.

A lead wire 31 is connected to the source electrode S and the drain electrode, and these lead wires 31 are enclosed by a shield cover 32, pass through the tubular portion 21b, and are guided to the outside. A DC power source and a load resistance (not shown) are connected to the lead wire 31. In FIG. 5, the protective diode for preventing electrostatic breakdown of the MOSFET 11 is not shown.

When the configuration is as shown in FIG. 5, there is no possibility that external noise is mixed in the lead wire between the probe 21 and the gate electrode G, and erroneous operations of the MOSFET 11 can be prevented.

In the spherical portion 21a, a component including the MOSFET 11 and a plurality of ion balance-detecting resistances R₁, R₂, R₃, . . . can be built in, as shown in FIG. 4, and needless to say, the p-channel MOSFET 12 can be used.

In the present embodiment, not only the spherical portion 21a and the tubular portion 21b are integrated and formed of a conductive member as shown in FIG. 5, but also the spherical portion 21a can be formed of a conductive member and operated as an antenna, and the tubular portion 21b can be formed of an insulator. Further, the spherical portion 21a and the tubular portion 21b can be formed of a conductive member and electrically separated by an insulator, and while the spherical portion 21a is operated as an antenna, the tubular portion 21b can be grounded. In this case, ions near the grounded tubular portion 21b are not detected, and absorbed from the tubular portion 21b to the earth.

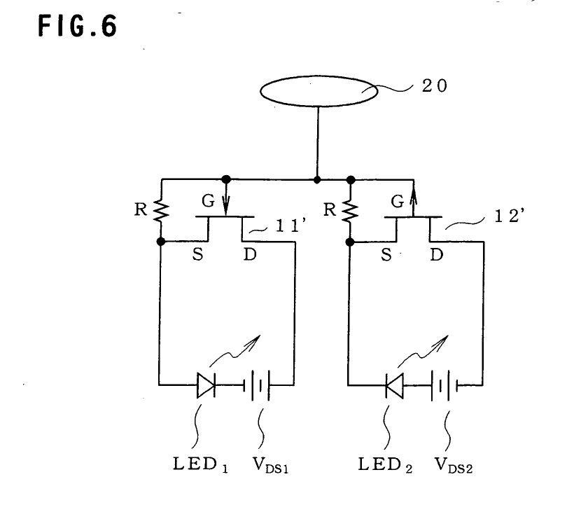

FIG. 6 is a circuit configuration of a fifth embodiment of the present invention, which corresponds to the invention of claim 2. The fifth embodiment enables visual display of the ion balance.

In FIG. 6, an n-channel MOSFET 11′ and a p-channel MOSFET 12′ are both normally-off type (enhancement type), and the gate electrodes G thereof are both connected to the antenna 20. Further, the ion balance-detecting resistance R is connected between the gate electrode G and the source electrode S in each of the MOSFETs 11′ and 12′. Also in this figure, the protective diode is not shown.

A light-emitting diode LED₁ and a DC power source V_{DS1} are serially connected between the source electrode S and the drain electrode D of the MOSFET 11′, and a light-emitting diode LED₂ and a DC power source V_{DS2} are serially connected between the source electrode S and the drain electrode D of the MOSFET 12′. The luminescent color of the light-emitting diodes LED₁ and LED₂ are different, for example, one is red and the other is green.

According to the above configuration, depending on unbalance of the positive and negative ions used for charging the antenna, for example, when there are positive ions more than negative ions, the light-emitting diode LED₁ can be allowed to emit light, and when there are negative ions more than positive ions, the light-emitting diode LED₂ can be allowed to emit light. Thus, the positive and negative ion balance can be visually displayed by separating the color.

Although not shown, also in this embodiment, a plurality of ion balance-detecting resistances can be provided so as to be changed over, or the antenna 20 can be formed in the shape of the probe 21 shown in FIG. 5, and components other than the light-emitting diodes LED₁ and LED₂ and the DC power sources V_{DS1} and V_{DS2} can be built in the spherical portion thereof.

According to respective embodiments of the present invention, a practical and inexpensive ion balance sensor can be provided only by adding some parts to the MOSFET.

In the respective embodiments, an instance in which a stand-alone MOSFET is used has been explained; however, the present invention is also applicable to an MOSFET formed in an input stage of an operation amplifier, which is a so-called FET input operation amplifier.

1. An ion balance sensor comprising:
an antenna charged with positive ions or negative ions; and
a normally-on type MOSFET in which the antenna is connected to a gate electrode, an ion balance-detecting resistance is connected between a grounded source electrode and the gate electrode, and a DC power source and a load resistance are serially connected between the source electrode and a drain electrode,
wherein a voltage of the gate electrode is changed due to a voltage drop by a current flowing between the charged antenna and an earth via the ion balance-detecting resistance, and a change of drain current due to the voltage of the gate electrode is detected, thereby detecting positive and negative balance of ions used for charging the antenna.

2. An ion balance sensor comprising:
an antenna charged with positive ions or negative ions; and
a normally-off type n-channel MOSFET and a normally-off type p-channel MOSFET, in each of which the antenna is connected to a gate electrode, an ion balance-detecting resistance is connected between a grounded source electrode and the gate electrode, and a DC power source and a light-emitting diode are serially connected between the source electrode and a drain electrode,
wherein a voltage of the gate electrode is changed due to a voltage drop by a current flowing between the charged antenna and an earth via the ion balance-detecting resistance, and a drain current of either one of the MOSFETs is increased by the voltage of the gate electrode, so that the light-emitting diode on this MOSFET side is allowed to emit light, thereby detecting positive and negative balance of ions used for charging the antenna.

3. The ion balance sensor according to claim 1 or 2, wherein the ion balance-detecting resistance is formed of a plurality of resistances having a different value of resistance, and one of the resistances is selected and connected between the source electrode and the gate electrode.

4. The ion balance sensor according to claim 1 or 2, wherein a hollow space is formed by a probe constituting the antenna, and the MOSFET including the gate electrode and the ion balance-detecting resistance are built in the space.

5. The ion balance sensor according to claim 1 or 2, wherein a resistance of the ion balance-detecting resistance is set to be smaller than a resistance in the opposite direction of a protective diode connected between the source electrode and the gate electrode of the MOSFET for preventing electrostatic breakdown.
